(19) United States
(12) Patent Application Publication
(10) Pub. No.: US 2019/0306030 A1
(43) Pub. Date: Oct. 3, 2019

(54) Modular Meshed Radio Nodes Networking Topology for Kinematic Objects

(71) Applicant: Kuang Yi Chen, Boulder, CO (US)

(72) Inventor: Kuang Yi Chen, Boulder, CO (US)

(21) Appl. No.: 16/366,359

(22) Filed: Mar. 27, 2019

Related U.S. Application Data
(60) Provisional application No. 62/650,267, filed on Mar. 29, 2018.

(51) Int. Cl. H04L 12/24; H04B 7/0413; H04L 12/721; H04W 76/15

(52) U.S. Cl. CPC H04L 41/12; H04B 7/0413; H04W 88/06; H04W 76/15; H04L 45/12

(57) ABSTRACT

A modular meshed radio nodes networking topology for kinematic objects utilizing a cellular or satellite backhaul communication component having a secondary wireless data transmission, an article, and a portable electronic device, the system including a power supply and data communication hub in a first electrical communication with the backhaul. Included is a plurality of independent radio transceivers each with an integral antenna array, plus can include beam forming, machine learning, and cryptographic encryption, each radio is removably engagable to an article, wherein each radio is in a second electrical communication with the power and data hub. Resulting in a primary wireless data transmission to or from the device to at least one of the radios that in turn send or receive data via the second electrical communication to the power and data hub for ultimate data communication via the first electrical communication to or from the backhaul.

### RELATED APPLICATION

This application claims the benefit of U.S. provisional patent application Ser. No. 62/650,267 filed on Mar. 29, 2018 by Kuang Yi Chen of Boulder, Colo., U.S.

### FIELD OF THE INVENTION

The present invention generally relates to radio node systems. More particularly, the present invention discloses a radio node system for specific applications in aircraft, cargo shipping, transportation, vehicles, and the like.

### DESCRIPTION OF THE RELATED ART

Looking in particular at the aircraft application including passenger, cargo, and other aircraft types, current wireless communication systems have significant complication and infrastructure wherein a large number of these systems are retrofits to current aircraft making installation challenging with aircraft cabin routing of thick and rigid antenna wires, consuming space and weight that are always at a premium on an aircraft, in addition to the required regulatory approvals that are required for these retrofits on aircraft. A further issue is with the inherent nature of the fast wireless technology evolution of these systems that would require frequent upgraded cable and component installation which would also affect newer aircraft that had their original factory installed system that is relatively quickly outdated technically, so that the newer aircraft soon become retrofit situations. Also, the existing wireless systems can't provide seamless roaming coverage for applications in the kinematic object such as aircraft, vehicles, ships and the like. The current wireless systems typically also use separate power ports to power wireless systems instead of using Power over Local Area Network (LAN) Technology.

As consumers now commonly posses personal data devices in the form of smart phones, tablet computers, and laptop computers, the need for wireless data transmission is ever increasing with the requirements of; large amounts of data, speed of data transmission, internet access from remote locations (air & ground), high density of wireless data users in a relatively confined space, a surrounding metal structure that can interfere with wireless data transmission, environmental factors-such as extremes in RF multipath, temperature, pressure, humidity, and the like for these systems can all present unique challenges toward keeping the system functioning well.

In the wireless communication system prior art in U.S. Pat. No. 5,345,599 to Paulraj et al., disclosed is an older multiple in multiple out (MIMO) system for reference that seeks to split up signals and recombine them in the wired cable networks for parallel transmission and reception via spatial distribution and directional reception for the purpose of increasing information transmission capacity. Paulraj teaches MIMO that splits up the signal is for the static wire network cable domain, and does not teach wireless MIMO features within the radio system, plus, Paulraj does not teach MESH network capabilities.

Further, in the wireless communication system prior art in U.S. Pat. No. 9,420,314 to Dame (assigned to Boeing), disclosed is an in-flight entertainment distribution to Personal Data Devices (PDA's) system using a media server in the aircraft that distributes over an Ethernet network with multiple In Flight Entertainment (IFE) units within the aircraft that have a USB port for each passenger seat, wherein Dame '314 indicated that Wi-Fi bandwidth capacity for all passengers watching movies would be inadequate. Dame '314 appears to not facilitate an interactive internet connection for the passenger, wherein the novelty is in the conversion of Ethernet to USB, in other words an intranet wired system within the plane. Further Dame '314 does not teach wireless data distribution plus either using MIMO or MESH networking. Dame '314 further does not teach power supply method of this system.

Continuing, in the wireless communication system prior art in U.S. Pat. No. 9,462,300 to Couleaud et al., disclosed is a distributed seat centric wireless in-flight entertainment system that has a plurality of wireless access points that each include memory, a radio transceiver, and processor-with entertainment content electronically stored in the access point, again this is an intranet system for just the plane that is wireless with no interactive internet access.

Yet, further in the wireless communication system prior art in U.S. Pat. No. 9,596,142 to Claudel et al., (assigned to Airbus), disclosed is a wireless partitioned on-board telecommunication network having multiple wireless access points (AP) that are separated into multiple sub network domains that do not cross talk with one another via using different communication standards, i.e. Wi-Fi, Bluetooth, GSM, etc., wherein system access to external internet is not taught. In Claudel's approach, media server and mass storage is integrated into each wireless AP, which will result in larger power consumption and increase the size of the wireless AP. Further, Claudel does not teach wireless MESH interactive network technology.

Again, in the wireless communication system prior art in U.S. Pat. No. 9,628,840 to Bleacher et al., disclosed is a wireless entertainment vehicle system that communicates entertainment content, that includes a battery powered portable housing that has a transceiver, processor, and memory (having standalone entertainment content) that wirelessly communicates with a Personal Electronic Device (PED), wherein the system is configured to fit in an airliner galley equipment rack. Also in Bleacher, this is an intranet system within the vehicle, wherein no internet access is taught. Further, Bleacher does not teach wireless MESH networking and due to uncertain battery life would prove to be too unreliable for normal usage.

Next, in the wireless communication system prior art in U.S. Pat. No. 9,654,808 to Dame (assigned to Boeing and being a continuation of U.S. Pat. No. 9,420,314), disclosed is an in-flight entertainment distribution to Personal Data Devices (PDA's) using a media server in the aircraft that distributes over an Ethernet network with multiple In Flight Entertainment (IFE) units within the aircraft that have a USB port for each passenger seat, wherein Dame '314 indicated that Wi-Fi bandwidth capacity for all passengers watching movies would be inadequate. Dame '808 appears to not facilitate an interactive internet connection for the passenger, wherein the novelty is in the conversion of Ethernet to USB, in other words an intranet system within the plane. Further Dame '808 does not teach wireless data distribution plus either using wireless MIMO or wireless MESH networking.

Continuing, in the wireless communication system prior art in United States Patent Application Publication Number US 2017/0310543 to Greig et al, disclosed is a plurality of distributed wireless access points that are battery powered that each wirelessly communicate to passenger devices with multiple antennas multiple in multiple out (MIMO), also the access point can have memory to store entertainment content plus have the option to connect to the internet, wherein the access points are swapped out between flights for battery charging or memory content refreshment. The novelty in Greig is in the access point devices that are assumed to connect to the planes existing in flight entertainment (IFE) system, thus being essentially signal boosters and signal diffusers. Greig does not disclose wireless MESH networking for self-organizing, self-healing, or real time routing algorithms and seamless roaming capabilities, also in Greig similar to Bleacher in utilizing batteries to power the wireless access point has very limited utility due to battery life constraints. Further, Greig doesn't teach the Power over LAN technology for the wireless access points.

These cited references give an idea of the current state of the art in the vehicle/airplane wireless communication system related arts via diffused Wi-Fi systems. A number of common issues do appear from the above cited references in the following areas being;

1. Addressing the high density of users in the airplane cabin (highest for Wi-Fi usage).
2. Addressing the unique problems with the challenging radio frequency (RF) environments in the kinematic object with confined RF multiple paths spacing such as the airplane cabin structure-being typically a long thin aluminum tube or alternatively a hybrid of metals/composites on wireless signals, plus including the cargo area for sensor applications to monitor individual cargo status for position, temperature, environmental camera, movement, various gases/liquids that are environmentally present, and the like.
3. Accommodating the airplane environment, i.e. power available, plus temperature, humidity, and pressure variations.
4. Further accommodating internet access in remote areas (both in air and on the ground).
5. Ease of installation in existing aircraft and ease of upgrades to existing installed systems and reduce installation wiring to keep up with the revolution of wireless MIMO and MESH networking technology.
6. Other form factors of small size and low weight structurally for aircraft use.

What is needed is a wireless communication system that addresses the above specific application issues 1 to 6, for a complete airplane passenger internet access system that would also have utility for airplane cargo in tracking an article of cargo, and other applications such as heavy equipment, warehouses, and the like. In addressing item 1 above wireless MIMO would increase Wi-Fi capacity and self-organized and self-healing, scalable MESH network would strengthen wireless coverage and provide better support for seamless roaming capabilities. Further, in addressing item 2 above the use of multiple access points so that all user with wireless personal data devices have direct access to a wireless signal instead of signals bouncing from the aluminum cabin structure. Further, these wireless access points are using power over LAN technology to remove or reduce additional power wiring cables and additional power regulation, power protection and power filtering from the unregulated aircraft power. Also in addressing item 3 above, a desirable wireless system would structurally facilitate as much of the system as possible to be in non-environmentally controlled conditions (i.e. the cargo bay) to ease the burden on space available in the environmentally controlled area (passenger cabin) of the aircraft. Item 4 above is important to the function of the wireless communication system being the backhaul component, however, not being a part of the present invention. Continuing, item 5 above is very important in facilitating easy upgrades to the system that would be essentially “plug and play” for the multiple wireless radio transceivers for hardware and software upgrades over time (being snap-in replacement devices), thus minimizing or even eliminating hardwire changes and/or component hard bolt in changes within the aircraft as required for replacement, upgrades, and additions for the wireless radio transceivers.

Essentially the present invention is combining Wireless Radios in the kinematic object to form intelligent radio nodes with antenna array-plus utilizing beam forming with adaptive/switched beam antenna array signals, that separates the router from Wireless Radio functionality, i.e. the Wireless Radios in the antenna array and not in the router to facilitate easier upgrades to the Wireless Radios and antenna array via a plug and play arrangement to replace and upgrade the Wireless Radios and antenna array without having to physically disturb the router, existing wired network, including components such as the servers and existing antennas for the backhaul component. An additional feature is that the Wireless Radios have machine learning for network management for routing between the mesh nodes and wireless channel assignment data rate adaption between the mesh nodes. Another feature of the present invention is to have wireless data network access and data transfer security encryption through public/private keys encryption in the MESH network infrastructure for the wireless access and wireless transmission of the Wireless Radios.

### SUMMARY OF INVENTION

Broadly, the present invention is a modular scalable meshed radio nodes networking topology for kinematic objects utilizing a cellular or satellite backhaul communication connection component having a secondary wireless data transmission. Included in the system is a plurality of independent radio transceivers each with plurality of integral antenna array for MIMO operation, each radio is removably engagable to an article, wherein each radio is in a second electrical communication with the power and data hub. The power of each radio node in this networking topology is sourced from a central power supply with regulated, protected, and filtered power outputs and a data communication hub or switch via power of local area network (LAN) cable network that that is also in a first electrical communication with the backhaul connection component.

Not only the central power supply in the system provides data and power connection to the electronics devices (such as radio nodes, wired VOW phones, portable wireless devices or other compatible devices, etc.), but also has input and output ports for monitoring and control functions in the system. When there is more than one radio node in this system, these independent radio transceivers are capable for forming a self-organized, self-healing, and dynamically routing wireless mesh network within kinematic object or between the kinematic objects. Wherein the system is to facilitate a primary wireless data transmission to or from the device to at least one of the radios that in turn send or receive data via the second electrical communication to the central power and data hub for ultimate data communication via the first electrical communication to or from the backhaul utilizing the secondary wireless data transmission.

Further included in the modular meshed radio nodes networking topology for kinematic objects is the plurality of independent radio transceivers each with plurality of an integral antenna array forming an access point, wherein each radio transceiver has structure to be removably engagable to a selected article, wherein each radio transceiver is in a second electrical communication with the central power and data hub/switch/router. Wherein the modular meshed radio nodes networking topology for kinematic objects is to operationally facilitate a primary wireless data transmission to or from the portable electronic device to at least one of the radio transceivers that in turn send or receive data via the second electrical communication to the central power and data hub/switch/router for ultimate data communication via the first electrical communication to or from the cellular, microwave, radio frequency or satellite backhaul connection component utilizing the secondary wireless data transmission.

The modular, scalable meshed radio nodes networking topology for kinematic objects is preferably a self organized, self healing, self configured system (with manual override option, the manual configuration can be performed locally or remotely over the cloud) to help provide seamless roaming, being lightweight and small in size, hot swappable, having MIMO and MESH networking, wherein the radio transceivers are powered through a local area network cable (power over LAN) from the regulated, protected and filtered power source via a centralized power supply that is originated outside of the radio transceivers, wherein the radio transceiver can either be central hub connected or daisy chained to be in the second electrical communication and powered via the central power supply with one another or combination thereof. The radio transceivers can facilitate on board devices for crews, passenger, equipment needs, or can gather information from sensors placed on items of cargo. The central power supply can be upsized as the size of the network is increased.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a schematic diagram of the modular, scalable, meshed radio nodes networking topology for kinematic objects showing a backhaul communication component, a central power and data communication hub/switch/router, a plurality of radio transceivers, wired VOIP phones, a plurality of sensors, and a smart phone, a tablet computer, and a laptop computer. FIG. 1 can also be a MIMO and/or MESH system that supports multiple virtual Local Area Networks (VLAN's) with the capability of multiple central power and data communication hub s/switch/router in larger installations;

FIG. 2 shows a layout diagram of the modular meshed radio nodes networking topology for kinematic objects that includes the backhaul communication component, the central power and data communication hub and the plurality of radio transceivers, plus wired VOIP phones;

FIG. 3 shows a cross section of an airliner fuselage showing the split of an upper passenger cabin and a lower below floor cargo area for the positional placement of the modular meshed radio nodes networking topology for kinematic objects within the airliner fuselage, wherein shown is the backhaul communication component, the central power and data communication hub, the plurality of radio transceivers, the plurality of sensors, and the smart phone, the tablet computer, and the laptop computer, plus a plurality of articles, a plurality of locations, and articles of cargo in their bins;

FIG. 4 is view 4-4 from FIG. 3 with FIG. 4 showing a cross cut end view of the airliner fuselage showing the split of the upper passenger cabin and the lower cargo area for the positional placement of the modular meshed radio nodes networking topology for kinematic objects within the airliner fuselage, wherein shown is the backhaul communication component, the plurality of radio transceivers, the plurality of sensors (sensors overlay network), and wired phone, smart phone, the tablet computer, and the laptop computer, plus a plurality of articles, a plurality of locations, and articles of cargo in their bins;

FIG. 5 shows a top cross sectional view of an aircraft fuselage with the roof removed to expose the seats in first/business class and coach plus the cockpit and the rear being the fore and aft sections of the typical airliner fuselage, further shown is the typical positional placement of the prior art Wi Fi antennas and the omni directional propagation of the prior art wireless radio beams from each Wi Fi antenna showing the misfit relationship of the prior art wireless radio beams to the typical aircraft fuselage shape, this misfit causes wasted energy, lower Wi Fi performance, requires more power, increases the need for additional Wi Fi antennas with correspondingly more hard wiring in the fuselage, and faster user portable wireless device (phone, tablet, etc.) battery drain down;

FIG. 6 shows a top cross sectional view of an aircraft fuselage with the roof removed to expose the seats in first/business class and coach plus the cockpit and the rear being the fore and aft sections of the typical airliner fuselage, further shown is the typical positional placement of the present invention intelligent wireless radio nodes with antenna array and the smart directional propagation of the present invention wireless radio beams from each intelligent wireless radio node with antenna array showing the improved fit relationship of the present invention wireless radio beams to the typical aircraft fuselage shape resulting in a better wireless radio beam match to the fuselage shape, this better match results in better Wi Fi coverage, faster data transfer, reduced Wi Fi dead zones, fewer radio nodes required, less electrical power required, slower user portable wireless device (phone, tablet, etc.) battery drain down, and less wireless data external interference;

FIG. 7 shows a schematic flow chart layout of the high level system architecture of the present invention integration into the in flight communication/entertainment system (IFC/IFE) starting from left to right with the bearer or backhaul portion that provides internet access to for instance the aircraft, then proceeding to the server and router, and further to specifically the present invention of the access points and remote antennas being combined into intelligent wireless radio nodes, plus the wiring which is integral to the aircraft fuselage;

FIG. 8 shows a schematic flow chart layout comparing the typical installation overall requirements for an IFC/IFE system as between the typical prior art Wi Fi system and the present invention emphasizing the simplicity the of present invention over the prior art to accomplish the same function with fewer components requiring less cabling, routers, and antennas than compared to the prior art;

FIG. 9 shows a schematic flow chart layout comparing the typical Wi Fi 802.11 upgrade installation overall requirements for an IFC/IFE system as between the typical prior art Wi Fi system and the present invention emphasizing the simplicity for upgrade the of present invention over the prior art upgrade to accomplish the same upgrade function with fewer components wherein the prior art upgrade requires new routers, new power cable, new data cable, new antennas, new antenna cables, and a more involved Supplemental Type Certificate (STC) as opposed to the present invention upgrade only requiring plug and play replacement of the intelligent wireless radio nodes with antenna arrays;

FIG. 10 shows a table form of comparison as between the prior art Wi Fi IFC/IFE system and the present invention Wi Fi IFC/IFE system showing that the present invention requires far fewer components than the prior art for accomplishing the same function;

FIG. 11 shows a continuing table form of comparison from FIG. 10 that again is between the prior art Wi Fi IFC/IFE system and the present invention Wi Fi IFC/IFE system showing that the present invention requires far fewer components than the prior art for accomplishing the same function in terms of components, weight, estimated costs, aircraft downtime and hassle;

FIG. 12 shows a table of overall benefits of the present invention in relation to use of the IFC/IFE system in an airliner fuselage;

FIG. 13 shows a table of installation benefits of the present invention in relation to use of the IFC/IFE system in an airliner fuselage; and

FIG. 14 shows a table of upgrade installation benefits of the present invention in relation to use of the IFC/IFE system in an airliner fuselage.

### DEFINITIONS

### Backhaul Link

Being the secondary wireless data transmission from an internet service provider that can include satellite, cellular, microwave, radio frequency, and the like

### Beam Forming

The capability to concentrate the power of the beams in the desired direction from the radio node to the user device (phone, tablet, laptop, etc,) to increase the transmitting distance, the signal and noise ratio, and decrease the bit error to the user device

### Bearers—

Internet Service Provider (ISP) through a physical communication channel that can include satellite, cell, and the like

### Central Power

Electrical power that is conditioned and protected from a centralized location

### Channels

Refers to a specific frequency range that comprises a specific channel forming a bandwidth for that specific channel

### IFC—

In Flight Connectivity

### IFE—

In Flight Entertainment

### Kinematic Objects

Dynamic components that includes planes, trucks, boats, trains, and the like

### Leverage Multipath Signals

Utilize the information from multiple delayed signals within a specific channel that are from the same source

### Machine Learning

Utilize data from the users usage and network performance to form algorithms and statistical models that wireless management systems use to effectively perform a specific task without using explicit instructions for routing between the mesh nodes, wireless channel assignment, and data rate adaption between the mesh nodes

### MESH

Every node has the capability to connect to other nodes in a network making communication more fault tolerant and efficient via working around a malfunctioning node for instance

### MIMO

Multiple In Multiple Out operation circuitry in the radio transceiver

### MRO—

Maintenance Repair Overhaul

### Network

A collection of nodes, plus routers, servers, and other communication components that are connected together

### Nodes

Individual items forming a part of a network

### Signals

Wired or wireless data transmission (in the form of a beam)

### STC—

Supplemental Type Certificate-being required for aircraft structure/component changes

### XCVR—

Transceiver

### REFERENCE NUMBERS IN DRAWINGS

50 Modular meshed radio nodes networking topology for kinematic objects
52 Kinematic object
55 Backhaul communication component
60 Cellular, or microwave, RF, or laser backhaul communication component 55 being the backhaul component or bearers channels
65 Satellite backhaul communication component 55
70 Secondary wireless data transmission from the backhaul communication component 55 to typically an internet service provider
75 Plurality of spatially dispersed articles
80 Central power supply with regulated, protected, and filtered power outputs and power over LAN outputs (preferably being 8 wires or 4 wires)
85 Direct current to direct current converter regulator circuit of the central power supply 80
90 Direct current power input (or alternating current power input) to direct current to the direct current converter regulator circuit 85 being typically an airplane power supply or alternatively could be alternating current to direct current convertor regulator circuit 85, the power supply can include functions of surge, filtration, and other power output conditioning
95 Controlled, regulated, protected, and filtered, voltage direct current output from the direct current to direct current converter regulator circuit 85 to the network 175 via a portion of the second electrical communication 165
96 Power cable for the controlled, regulated, protected, and filtered, voltage direct current output 95
100 Data communication hub that can include switching, routing, and servers, and mass storage functions that may or may not be combined with the central power supply 80
105 Ethernet router or switch of the central power supply 80 and data communication hub/switch/router 100 that can also include Input and Output ports for monitoring and controlling functions.
110 Circuitry for hot swap of the regulator circuit 85 and/or the data communication hub 100
115 Circuitry for preferably utilizing either a four wire or an eight wire network cable system for the second electrical communication and powering 165
120 First electrical communication being from the data communication hub/switch/router 100 to the backhaul communication component 55
125 Radio transceiver preferably being intelligent radio nodes that can include as options MIMO 145, MESH 150, Wi Fi circuitry 155, Ultra Wide Band network 160, Beam forming circuitry 425, Cryptography circuitry for public/private key generation 430, and Deep Machine learning algorithm 435
130 Integral or internal antenna array of the radio transceiver 125 that can be multiple antennas 130
135 Access point of the radio transceiver 125
140 Structure for removable engageability for the radio transceiver 125 to a selected article 75 of the plurality of spatially dispersed articles 75
145 Circuitry for multiple in multiple out (MIMO) operation in the radio transceiver 125, the operation including the capability for leverage of the multipath and/or delayed signal from the same source of said primary wireless data transmission signals.
150 Circuitry for MESH network operation in the radio transceiver 125 that can include self organizing, self healing, or real time routing algorithm and with secured manual override configuration options either locally or over the cloud, further the MESH network also supports multiple virtual Local Area Networks (VLAN's)
155 Circuitry for Wi Fi network operation in the radio transceiver 125
160 Circuitry for Ultra Wide Band network operation in the radio transceiver 125
165 Second electrical communication typically being from the radio transceiver 125 to the data communication hub/switch/router 100 for data and power
170 Primary wireless data transmission being from and to the smart phone 300, tablet computer 305, or laptop computer 310 to the radio transceiver 125
175 Network that includes the central power supply 80, the data communication hub 100, the second electrical communication 165, and the plurality of radio transceivers 125
180 Airplane cabin typically having environmental control for temperature and pressure
185 Cargo or electronic bay area typically not having environmental control for temperature and pressure
190 Article of cargo
195 Plurality of spatially selected locations
200 Self contained sensor
205 Structure for removable engagement of the sensor 200 to the article of cargo 190
210 Circuitry for position detector in the sensor 200
215 Circuitry for temperature detector in the sensor 200
220 Circuitry for pressure detector in the sensor 200
225 Circuitry for light detector or camera in the sensor 200
230 Circuitry for acceleration detector, that can include magnetic or gyroscopic/inertial measurement detector in the sensor 200
235 Circuitry for unique sensor identification in the sensor 200
240 Perceptible component that can be wired VOIP phones or could utilize the second electrical communication 165 or sensor 200
245 Third electrical communication
300 Smart phone that could include VOIP phone that can either be wireless or could utilize the second electrical communication 165
305 Tablet computer
310 Laptop computer
315 Airplane cabin floor
320 Airplane cargo bin
325 Airplane cabin seats
330 Airplane cabin overhead storage
335 Airplane electrical power supply
400 Prior art Wi Fi antenna
405 Prior art Wi Fi wireless radio beam propagation
410 Cross section top view (roof removed) of an airliner fuselage showing a floor layout
415 Primary scope of the present invention 50 being the plurality of independent radio transceivers 125
420 Existing kinematic object 52 wiring
425 Beam forming circuitry
430 Cryptography circuitry for public/private keys generation
435 Deep Machine learning algorithms
500 Prior art connection to internet transceiver
505 Prior art Wi Fi antenna cable
510 Prior art router
515 Prior art data cable
520 Prior art power cable

### DETAILED DESCRIPTION

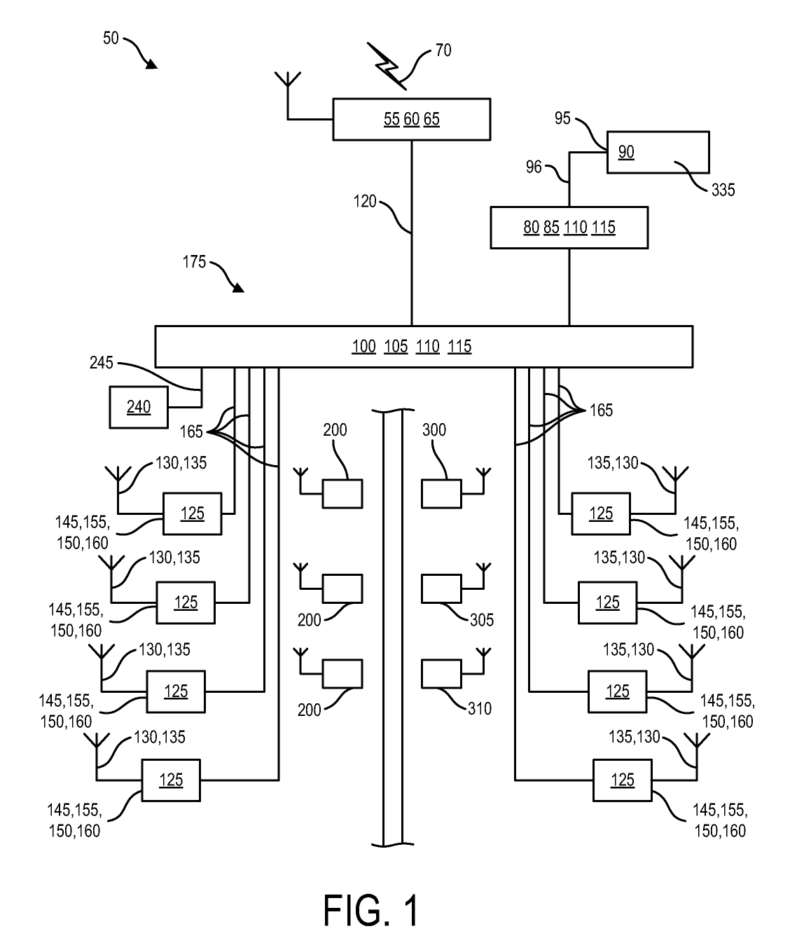

With initial reference to FIG. 1 shown is a schematic diagram of the modular meshed radio nodes networking topology for kinematic objects 50 showing the backhaul communication component 55, the central power 80 and data communication hub/switch 100, the plurality of radio transceivers 125, the plurality of sensors 200, and the smart phone 300, a tablet computer 305, the laptop computer 310 and preferably the wired VOIP phones 240 communicate from data hub/switch 100 to the backhaul communications system.

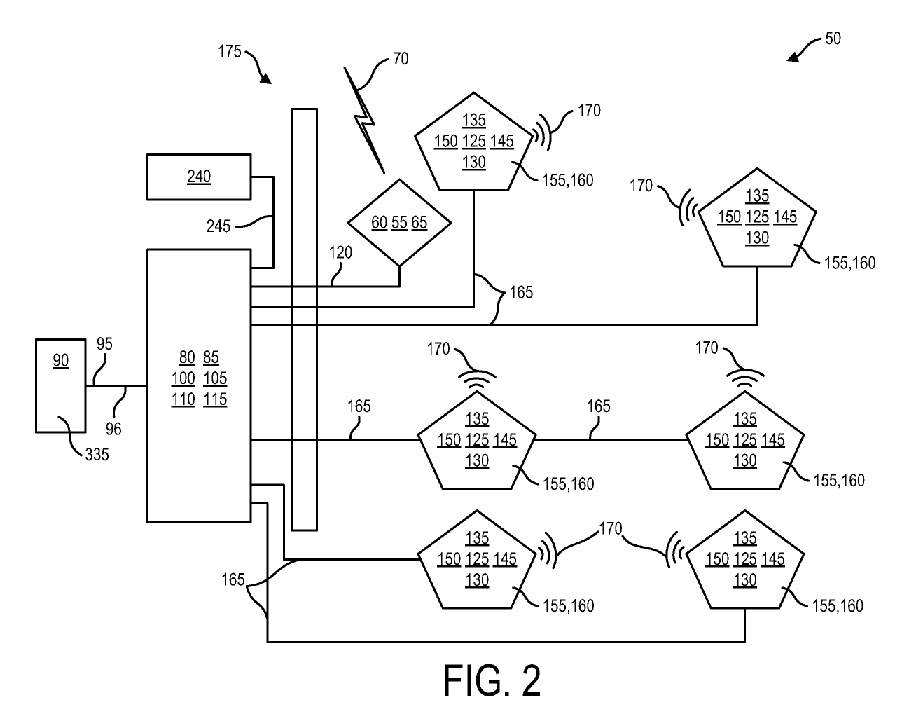

Next, FIG. 2 shows a layout diagram of the modular meshed radio nodes networking topology for kinematic objects 50 that includes the backhaul communication component 55, the central power 80 and data communication hub 100, and the plurality of radio transceivers 125. Note that the second electrical communication 165 can either be a spoke and hub design or a daisy chain design or a combination of spoke and hub and daisy chain as shown in FIG. 2. Also as shown in FIG. 2, preferably the wired VOW phones 240 communicate from data hub/switch 100 to the backhaul communications system.

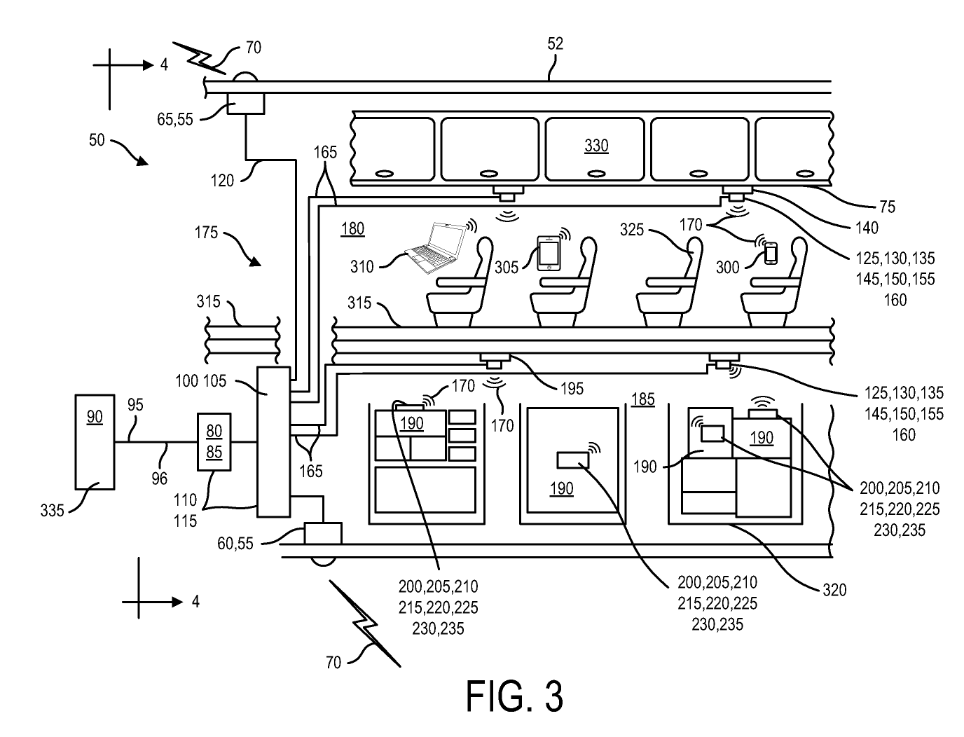

Continuing, FIG. 3 shows a cross section of an airliner fuselage showing the split of an upper passenger cabin 180 and a lower cargo area 185 for the positional placement of the modular meshed radio nodes networking topology for kinematic objects 50 within the airliner fuselage, wherein shown is the backhaul communication component 55. FIG. 3 also shows the central 80 and data communication hub 100, the plurality of radio transceivers 125, the plurality of sensors 200, and the smart phone 300, the tablet computer 305, and the laptop computer 310, plus a plurality of articles 75, a plurality of locations 195, and articles 190 of cargo in their bins 320.

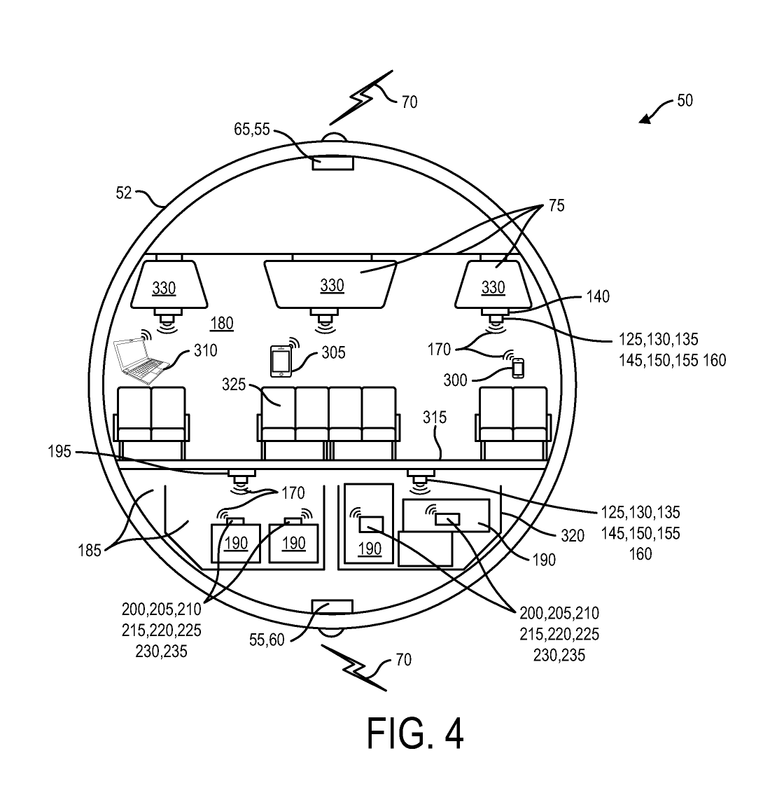

Further, FIG. 4 is view 4-4 from FIG. 3 with FIG. 4 showing a cross cut end view of the airliner fuselage showing the split of the upper passenger cabin 180 and the lower cargo area 185 for the positional placement of the modular meshed radio nodes networking topology for kinematic objects 50 within the airliner fuselage, wherein shown is the backhaul communication component 55. In addition, FIG. 4 shows the plurality of radio transceivers 125, the plurality of sensors 200, and the smart phone 300, the tablet computer 305, and the laptop computer 310, plus a plurality of articles 75, a plurality of locations 195, and articles 190 of cargo in their bins 320.

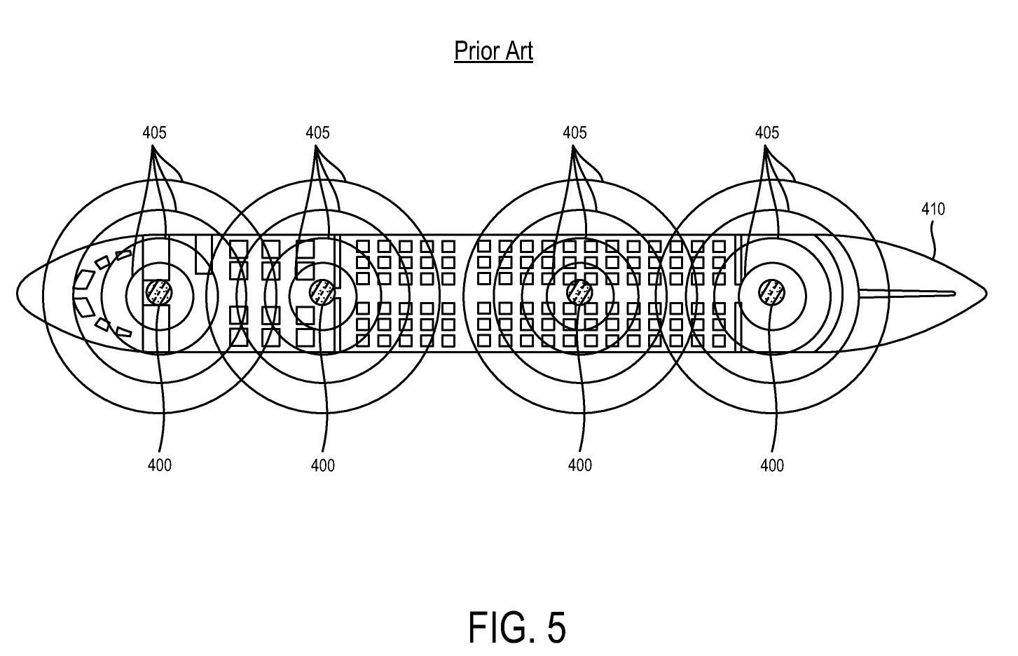

Continuing, FIG. 5 shows a top cross sectional view of an aircraft fuselage 410 with the roof removed to expose the seats in first/business class and coach plus the cockpit and the rear being the fore and aft sections of the typical airliner fuselage 410, further shown is the typical positional placement of the prior art Wi Fi antennas 400 and the omni directional propagation of the prior art wireless radio beams 405 from each Wi Fi antenna 400 showing the misfit relationship of the prior art wireless radio beams 405 to the typical aircraft fuselage shape 410, this misfit causes wasted energy, lower Wi Fi performance, requires more power, increases the need for additional Wi Fi antennas 400 with correspondingly more hard wiring in the fuselage 410, and faster user portable wireless device (phone, tablet, etc.) battery drain down.

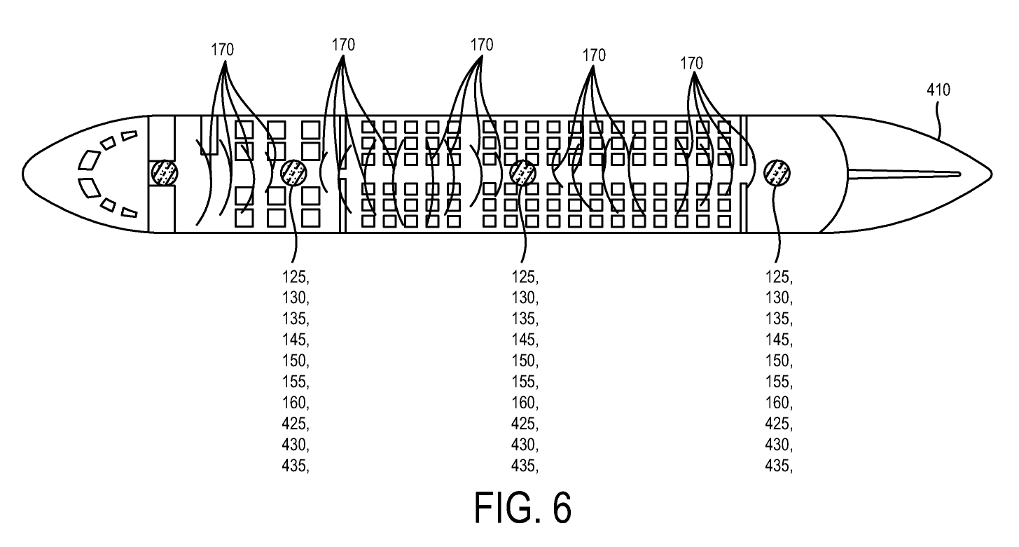

Further, FIG. 6 shows a top cross sectional view of an aircraft fuselage 410 with the roof removed to expose the seats in first/business class and coach plus the cockpit and the rear being the fore and aft sections of the typical airliner fuselage 410, further shown is the typical positional placement of the present invention intelligent wireless radio nodes 125 with antenna arrays and the smart directional propagation of the present invention wireless radio beams 170 from each intelligent wireless radio node 125 with antenna array showing the improved fit relationship of the present invention wireless radio beams 170 to the typical aircraft fuselage shape 410 resulting in a better wireless radio beam 170 match to the fuselage shape 410, this better match results in better Wi Fi coverage, faster data transfer, reduced Wi Fi dead zones, fewer radio nodes required, less electrical power required, slower user portable wireless device (phone, tablet, etc.) battery drain down, and less wireless data external interference.

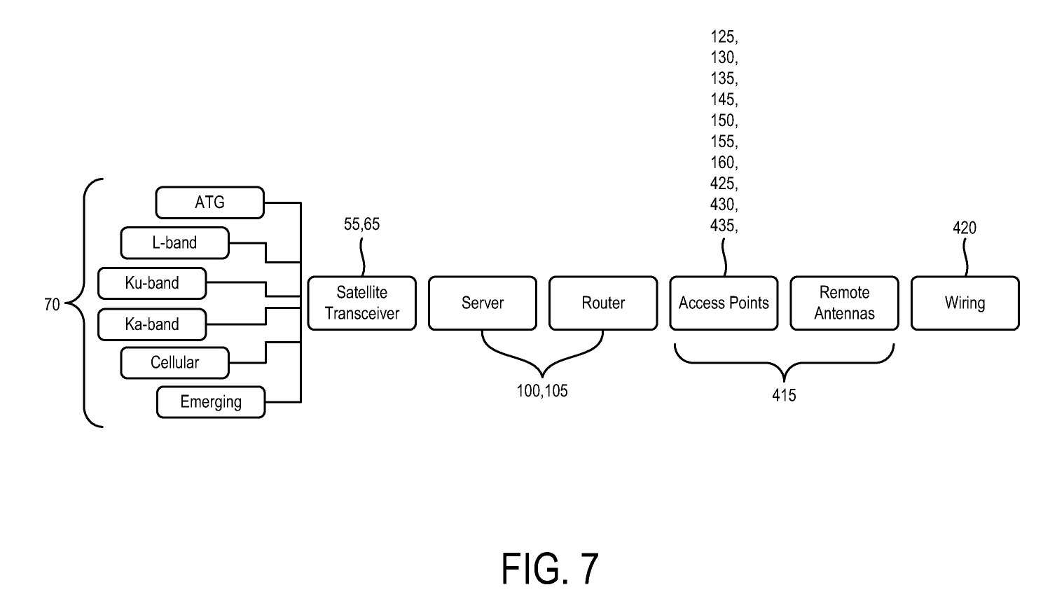

Next, FIG. 7 shows a schematic flow chart layout of the high level system architecture of the present invention 50 integration into the in flight communication/entertainment system (IFC/IFE) starting from left to right with the bearer 55 or backhaul 55 portion that provides internet access to for instance the aircraft 410, then proceeding to the server and router 100, 105, and further to specifically the present invention 50 primary scope 415 of the access points and remote antennas being combined into intelligent wireless radio nodes 125, plus the wiring 420 which is integral to the aircraft fuselage 410.

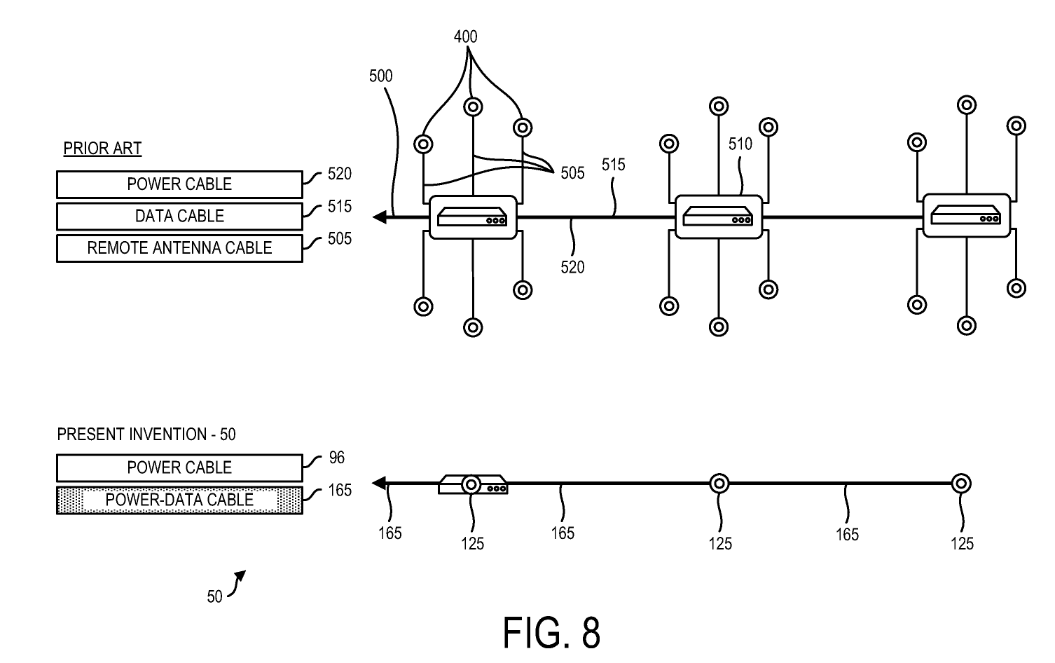

Moving onward, FIG. 8 shows a schematic flow chart layout comparing the typical installation overall requirements for an IFC/IFE system as between the typical prior art Wi Fi system 400, 505, 515, 500, and 520, and the present invention 50 emphasizing the simplicity the of present invention 50 over the prior art system 400, 505, 515, 500, and 520, to accomplish the same function with fewer components requiring less cabling, routers, and antennas than compared to the prior art system 400, 505, 515, 500, and 520.

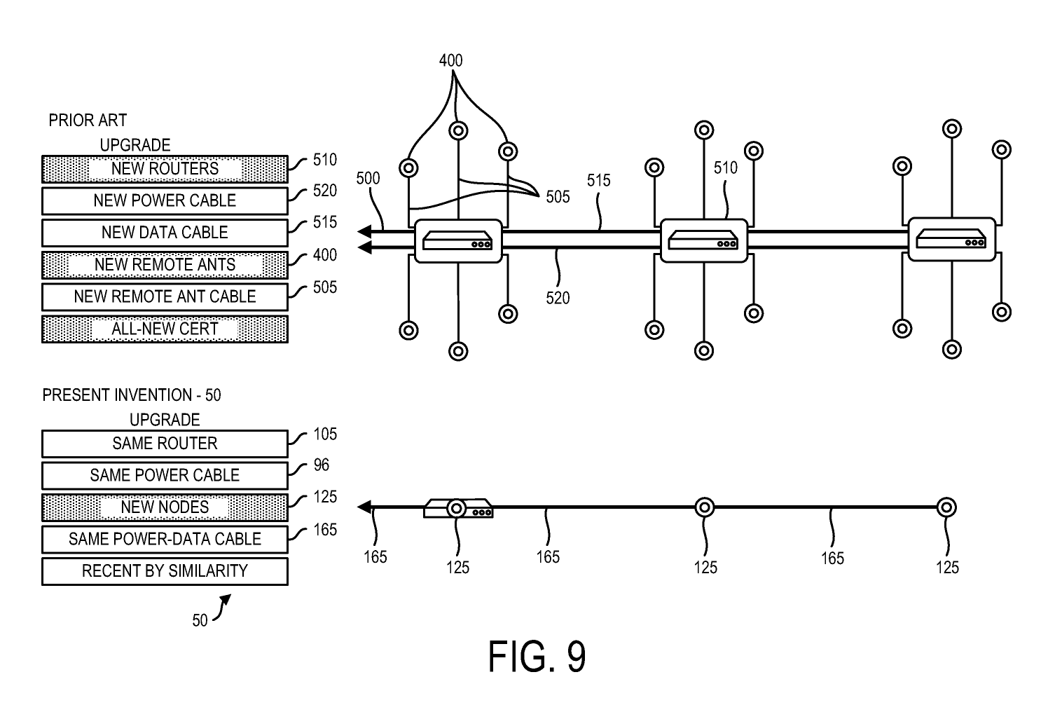

Continuing, FIG. 9 shows a schematic flow chart layout comparing the typical Wi Fi 802.11 upgrade installation overall requirements for an IFC/IFE system as between the typical prior art Wi Fi system 400, 505, 515, 500, and 520, and the present invention 50 emphasizing the simplicity for upgrade the of present invention 50 over the prior art system 400, 505, 515, 500, and 520, upgrade to accomplish the same upgrade function with fewer components wherein the prior art system 400, 505, 515, 500, and 520, upgrade requires new routers, new power cable, new data cable, new antennas, new antenna cables, and a more involved Supplemental Type Certificate (STC) as opposed to the present invention 50 upgrade only requiring plug and play replacement of the intelligent wireless radio nodes 125 with antenna array.

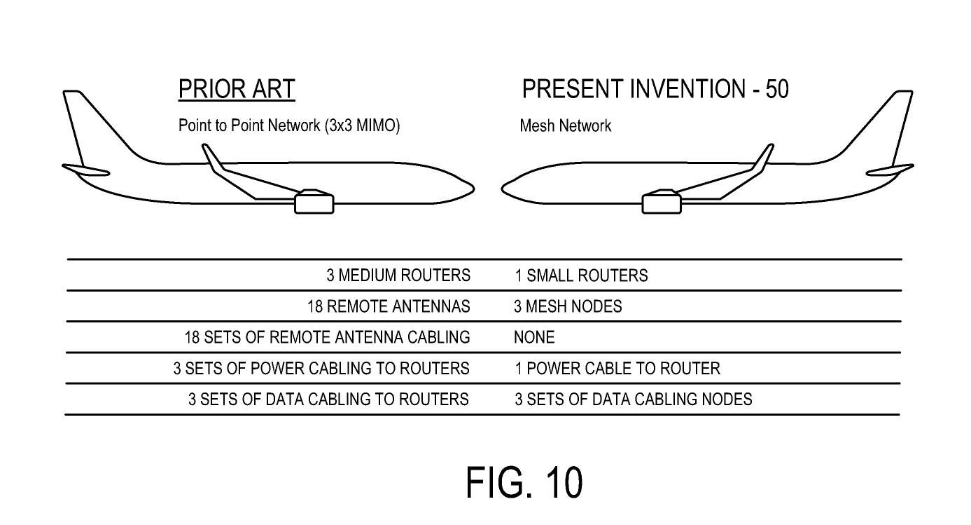

Further, FIG. 10 shows a table form of comparison as between the prior art Wi Fi IFC/IFE system 400, 505, 515, 500, and 520, and the present invention Wi Fi IFC/IFE system 50 showing that the present invention 50 requires far fewer components than the prior art 400, 505, 515, 500, and 520, for accomplishing the same function.

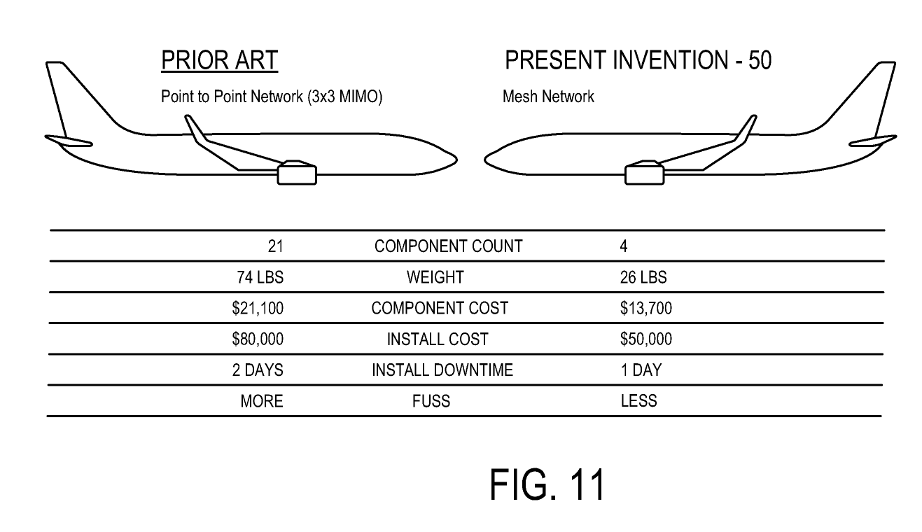

Next, FIG. 11 shows a continuing table form of comparison from FIG. 10 that again is between the prior art Wi Fi IFC/IFE system 400, 505, 515, 500, and 520, and the present invention Wi Fi IFC/IFE system 50 showing that the present invention 50 requires far fewer components than the prior art 400, 505, 515, 500, and 520, for accomplishing the same function in terms of components, weight, estimated costs, aircraft downtime and hassle.

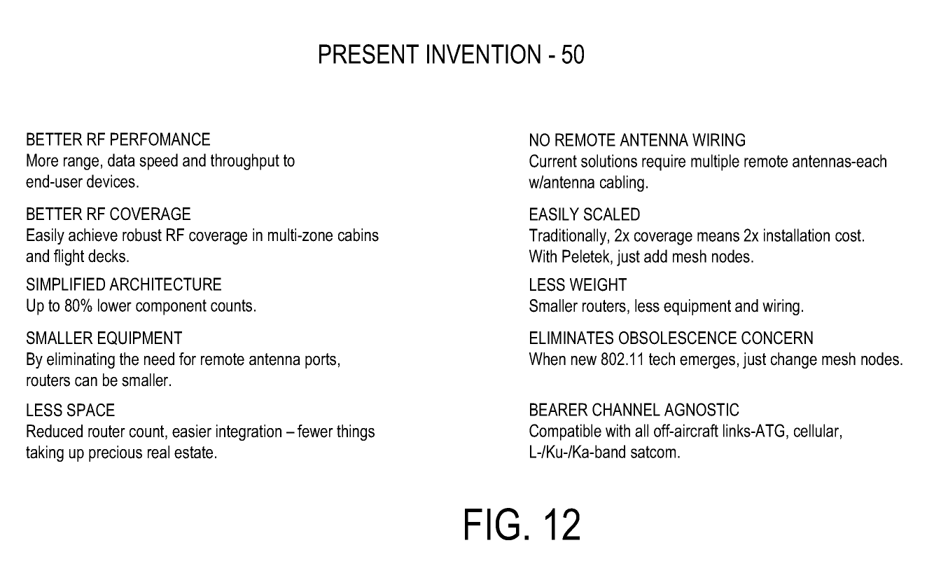

Continuing, FIG. 12 shows a table of overall benefits of the present invention 50 in relation to use of the IFC/IFE system in an airliner fuselage 410.

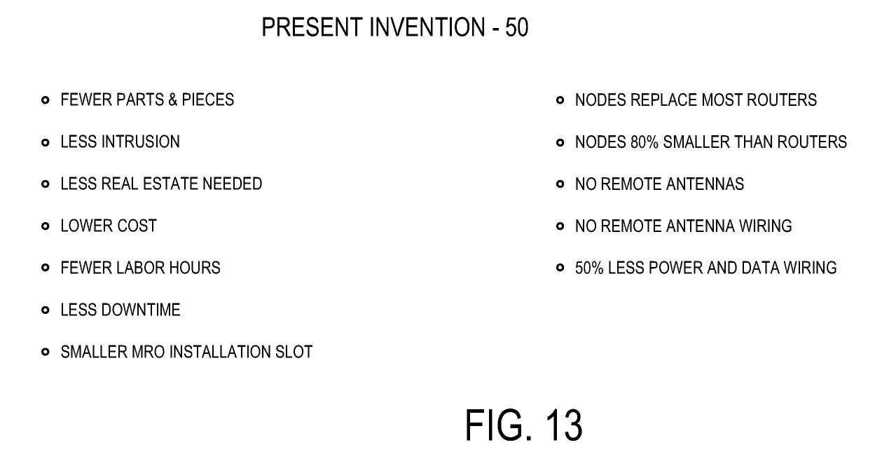

Also, FIG. 13 shows a table of installation benefits of the present invention 50 in relation to use of the IFC/IFE system in an airliner fuselage 410.

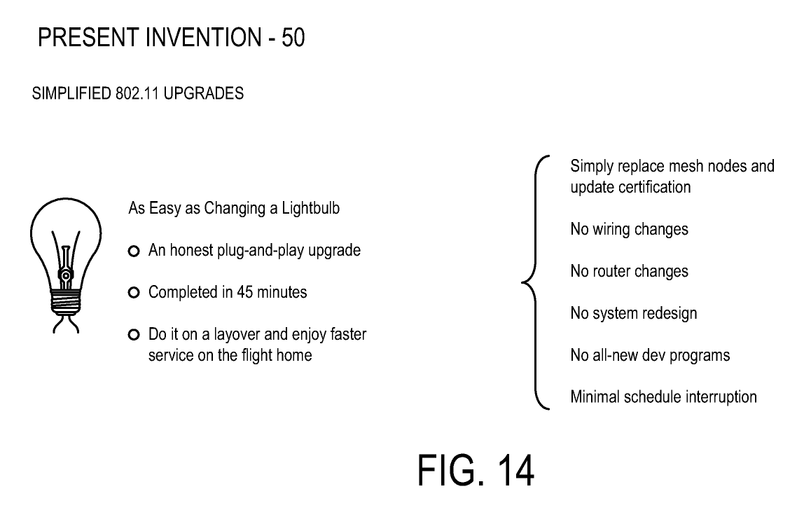

Further, FIG. 14 shows a table of upgrade installation benefits of the present invention 50 in relation to use of the IFC/IFE system in an airliner fuselage 410.

Broadly in looking at FIGS. 1 to 14, the present invention is the modular meshed radio nodes networking topology for kinematic objects 50 utilizing a cellular 60 or satellite 65 backhaul communication connection component 55 having a secondary wireless data transmission 70, the plurality of spatially dispersed articles 75, and the portable electronic device 300, 305, 310, the modular meshed radio nodes networking topology for kinematic objects 50 including the central power supply 80 and data communication hub 100 that is in a first electrical communication 120 with the backhaul connection component 55, seeing in particular FIGS. 1 to 3. Further included in the modular meshed radio nodes networking topology for kinematic objects 50 is the plurality of independent radio transceivers 125 each with the integral antenna array 130 forming an access point 135, wherein each radio transceiver 125 has structure 140 to be removably engagable to a selected article 75, wherein each radio transceiver 125 is in a second electrical communication 165 with the central power 80 and data hub 100, see FIGS. 3 and 4.

Wherein the modular meshed radio nodes networking topology for kinematic objects 50 is to operationally facilitate a primary wireless data transmission 170 to or from the portable electronic device 300, 305, 310 to at least one of the radio transceivers 125 that in turn send or receive data via the second electrical communication 165 to the central power 80 and data hub 100 for ultimate data communication via the first electrical communication 120 to or from the cellular 60 or satellite 65 backhaul connection component utilizing the secondary wireless data transmission 70, see FIGS. 2, 3, and 4.

As an option for the modular meshed radio nodes networking topology for kinematic objects 50 wherein at least one of the plurality of independent radio transceivers 125 can further comprise circuitry 145 for a multiple in multiple out (MIMO) operation.

A further option for the modular meshed radio nodes networking topology for kinematic objects 50 wherein the plurality of independent radio transceivers 125 each further comprise circuitry 150 for a mesh network operation, wherein the mesh network circuitry 150 is selected from the group consisting of a local network configuration or a backhaul (cloud) configuration.

Continuing for the options on the modular meshed radio nodes networking topology for kinematic objects 50 wherein the central power 80 and data hub 100 includes an Ethernet router or switch 105.

Yet a further option for the modular meshed radio nodes networking topology for kinematic objects 50 wherein the central power supply 80 and data communication hub 100 is constructed of a direct current to direct current converter regulator circuit 85 that receives a direct current (or alternating current) supply system power input 90, wherein the regulator 85 outputs a controlled, protected, and filtered voltage direct current network circuit power feed 95 via a portion of the second electrical communication 165. Also optionally for the modular meshed radio nodes networking topology for kinematic objects 50, a hot swap circuitry 110 is included in either or both the regulator circuit 85 and the data communication hub 100 to facilitate replacing, adding, or subtracting the radio transceivers 125 to and from the second electrical communication for both data and power 165 from the central power supply 80 and data communication hub 100 without shutting down the modular meshed radio nodes networking topology for kinematic objects 50.

Alternatively, for the modular meshed radio nodes networking topology for kinematic objects 50 wherein the direct current to direct current converter regulator circuit 85 and the data communication hub 100 can further comprise circuitry 115 to preferably utilize either four wire or eight wire network 175 cable systems for the second electrical communication 165 for both data and power by using power over LAN technology.

Another alternative for the modular meshed radio nodes networking topology for kinematic objects 50 utilizing the cellular 60 or satellite 65 backhaul communication connection component 55 utilizing the secondary wireless data transmission 70, a plurality of spatially selected locations 195 within the airplane cabin 180, and the portable electronic device 300, 305, 310, the modular meshed radio nodes networking topology for kinematic objects 50 includes the central power supply 80 and data communication hub 100 that is in the first electrical communication 120 with the backhaul connection component 55, see FIGS. 3 and 4 primarily, plus FIGS. 1 and 2.

Further included in the modular meshed radio nodes networking topology for kinematic objects 50 is the plurality of independent radio transceivers 125 each with the integral antenna array 130 forming the access point 135, wherein each radio transceiver 125 has structure 140 to be removably engagable to a selected location on an article 75 within the airplane cabin 180. Wherein each radio transceiver 125 is in the second electrical communication 165 with the central power 80 and data hub 100, wherein the modular meshed radio nodes networking topology for kinematic objects 50 is to operationally facilitate the primary wireless data transmission 170 to or from the portable electronic device 300, 305, 310 to at least one of the radio transceivers 125 that in turn send or receive data via the second electrical communication 165 to the central power 80 and data hub 100 for ultimate data communication via the first electrical communication 120 to or from the cellular 60 or satellite 65 backhaul connection component 55 utilizing the secondary wireless data transmission 70, see again FIGS. 3 and 4 primarily, plus FIGS. 1 and 2.

A further alternative for the modular meshed radio nodes networking topology for kinematic objects 50 utilizing the cellular 60 or satellite 65 backhaul communication connection component 55 utilizing the secondary wireless data transmission 70, a plurality of spatially selected locations 195 can be within the cargo area 185, and the article of cargo 190. The modular meshed radio nodes networking topology for kinematic objects 50 includes the central power supply 80 and data communication hub 100 that is in the first electrical communication 120 with the backhaul connection component 55, see FIGS. 1 to 3.

Further included in the modular meshed radio nodes networking topology for kinematic objects 50 is the plurality of independent radio transceivers 125 each with the integral antenna array 130 forming the access point 135, wherein each radio transceiver 125 has structure 140 to be removably engagable to the selected location 195 within the cargo area 185, wherein each radio transceiver 125 is in the second electrical communication 165 with the central power 80 and data hub 100, see FIGS. 3 and 4 primarily and also FIGS. 1 and 2.

Also included in the modular meshed radio nodes networking topology for kinematic objects 50 is the self contained sensor 200 including structure 205 to be removably engaged to the article 190 of cargo. Wherein the modular meshed radio nodes networking topology for kinematic objects 50 is to operationally facilitate the primary wireless data transmission 170 to or from the sensor 200 to at least one of the radio transceivers 125 that in turn send or receive data via the second electrical communication 165 to the central power 80 and data hub 100 for ultimate data communication via the first electrical communication 120 to or from the cellular 60 or satellite 65 backhaul connection component 55 utilizing the secondary wireless data transmission 70, see FIGS. 3 and 4 primarily and also FIGS. 1 and 2.

Additionally included in the modular meshed radio nodes networking topology for kinematic objects 50 is a perceptible component 240 that is in a third electrical communication 245 with the central power 80 and data hub 100, wherein the perceptible component 240 ultimately receives data from the sensor 200. Thus the perceptible component 240 can be a visual display within the airplane cockpit that gives indication of cargo 190 position, temperature, movement, identification, and the like to give notice to the airplane pilot on the status of the cargo for safety reasons for say cargo 190 shifting, cargo 190 fire, and the like. Further, the perceptible component 240 can be a 4 wire VOIP phone.

Further, optionally for the modular meshed radio nodes networking topology for kinematic objects 50 is wherein the radio transceivers 125 can further comprise circuitry that is either Wi Fi 155 or Ultra Wide Band 160.

In addition, optionally for the modular meshed radio nodes networking topology for kinematic objects 50 wherein the sensor 200 can further comprise circuitry selected from the group consisting of a position detector 210, a temperature detector 215, a pressure detector 220, a light detector 225, an acceleration, magnetic, gyroscopic/inertial measurement detector 230, or a unique sensor identification identifier 235, see FIGS. 3 and 4.

Also, optionally for the modular meshed radio nodes networking topology for kinematic objects 50, the antenna array assembly 130 can further comprise beam forming circuitry 425 to operationally create an adaptive array smart antenna array 130 to direct radio frequency energy 170 to where it is needed to establish the wireless primary wireless data transmission 170, see FIG. 6 in particular and FIGS. 1 to 4.

Further, optionally for the modular meshed radio nodes networking topology for kinematic objects 50, each radio transceiver 125 can further comprise circuitry for cryptography and key distribution 430 for node 125 to node 125 and access control for the mesh nodes 125, wherein public and private keys can be generated from each node 125 in the mesh network 150 or alternatively be generated from a server 100 and propagated to each node 125, see FIGS. 1 to 4 and FIGS. 6 to 9.

In addition, optionally for the modular meshed radio nodes networking topology for kinematic objects 50, wherein each radio transceiver 125 can further comprise deep machine learning algorithms 435 for network routing 175 to determine a network routing having a shortest reliable path, determine channel assignment to minimize interference level and data rate adaption based on the operating wireless environment, see FIGS. 1 to 4 and FIGS. 6 to 9.

### CONCLUSION

Accordingly, the present invention of a modular meshed radio nodes networking topology for kinematic objects has been described with some degree of particularity directed to the embodiments of the present invention. It should be appreciated, though; that the present invention is defined by the following claim construed in light of the prior art so modifications of the changes may be made to the exemplary embodiments of the present invention without departing from the inventive concepts contained therein.

1. A modular meshed radio nodes networking topology for kinematic objects utilizing a cellular or satellite backhaul or bearers communication connection component utilizing a secondary wireless data transmission, a plurality of spatially dispersed articles, and a portable electronic device, said modular meshed radio nodes networking topology for kinematic objects comprising:
(a) a central protected and conditioned power supply and data communication hub that is in a first electrical communication with the backhaul connection component; and
(b) a plurality of independent radio transceivers each with an integral antenna array forming an access point, wherein each said radio transceiver has structure to be removably engagable to a selected article, wherein each radio transceiver is in a second electrical communication with said central power and data hub, wherein said modular meshed radio nodes networking topology for kinematic objects is to operationally facilitate a primary wireless data transmission to or from the portable electronic device to at least one of said radio transceivers that in turn send or receive data via said second electrical communication to said central power and data hub for ultimate data communication via said first electrical communication to or from the cellular or satellite backhaul connection component utilizing the secondary wireless data transmission.

2. A modular meshed radio nodes networking topology for kinematic objects according to claim 1 wherein at least one of said plurality of independent radio transceivers further comprise circuitry for a multiple in multiple out (MIMO) operation including the capability for leverage of the multipath and/or delayed signal from the same source of said primary wireless data transmission signals.

3. A modular meshed radio nodes networking topology for kinematic objects according to claim 1 wherein said plurality of independent radio transceivers each further comprise circuitry for a mesh network operation, wherein said mesh network circuitry is selected from the group consisting of a local network configuration or a backhaul (cloud) configuration.

4. A modular meshed radio nodes networking topology for kinematic objects according to claim 1 wherein said central protected and conditioned power supply and said data hub includes an Ethernet switch or router.

5. A modular meshed radio nodes networking topology for kinematic objects according to claim 1 wherein said central protected and conditioned power supply and data communication hub is constructed of a direct current or alternating current to direct current converter regulator circuit that receives a current supply system power input, wherein said regulator outputs a protected and controlled voltage direct current network circuit power feed via a portion of said second electrical communication, in addition a hot swap circuitry is included in said regulator circuit and said data communication hub to facilitate replacing, adding, or subtracting said radio transceivers to and from said second electrical communication from said central power supply and data communication hub without shutting down said modular meshed radio nodes networking topology for kinematic objects.

6. A modular meshed radio nodes networking topology for kinematic objects according to claim 5 wherein said direct current or alternating current to direct current converter regulator circuit and said data communication hub further comprises circuitry to utilize either four wire or eight wire network cable systems for said second electrical communication.

7. A modular meshed radio nodes networking topology for kinematic objects according to claim 1 wherein said antenna array assembly further comprises beam forming circuitry to operationally create an adaptive array smart antenna array to direct radio frequency energy to where it is needed to establish said wireless primary wireless data transmission.

8. A modular meshed radio nodes networking topology for kinematic objects according to claim 3 wherein each said radio transceiver further comprises circuitry for cryptography and key distribution for node to node and access control for the mesh nodes, wherein public and private keys can be generated from each node in said mesh network or alternatively be generated from a server and propagated to each node.

9. A modular meshed radio nodes networking topology for kinematic objects according to claim 3 wherein each said radio transceiver further comprises deep machine learning algorithms for network routing to determine a network routing a shortest reliable path, determine channel assignment to minimize interference level and data rate adaption based on the operating wireless environment.

10. A modular meshed radio nodes networking topology for kinematic objects utilizing a cellular or satellite backhaul or bearers communication connection component utilizing a secondary wireless data transmission, a plurality of spatially selected locations on articles within an airplane cabin and a portable electronic device, said modular meshed radio nodes networking topology for kinematic objects comprising:
(a) a central protected and conditioned power supply and data communication hub that is in a first electrical communication with the backhaul connection component; and
(b) a plurality of independent radio transceivers each with an integral antenna array forming an access point, wherein each said radio transceiver has structure to be removably engagable to a selected location on the articles within the airplane cabin, wherein each radio transceiver is in a second electrical communication with said central power and data hub, wherein said modular meshed radio nodes networking topology for kinematic objects is to operationally facilitate a primary wireless data transmission to or from the portable electronic device to at least one of said radio transceivers that in turn send or receive data via said second electrical communication to said central power and data hub for ultimate data communication via said first electrical communication to or from the cellular or satellite backhaul connection component utilizing the secondary wireless data transmission.

11. A modular meshed radio nodes networking topology for kinematic objects according to claim 10 wherein at least one of said plurality of independent radio transceivers further comprise circuitry for a multiple in multiple out (MIMO) operation including the capability for leverage of the multipath and/or delayed signal from the same source of said primary wireless data transmission signals.

12. A modular meshed radio nodes networking topology for kinematic objects according to claim 10 wherein said plurality of independent radio transceivers each further comprise circuitry for a mesh network operation, wherein said mesh network circuitry is selected from the group consisting of a local network configuration or a backhaul (cloud) configuration.

13. A modular meshed radio nodes networking topology for kinematic objects according to claim 10 wherein said central protected and conditioned power supply and said data hub includes an Ethernet switch or router.

14. A modular meshed radio nodes networking topology for kinematic objects according to claim 10 wherein said central protected and conditioned power supply and data communication hub is constructed of a direct current or alternating current to direct current converter regulator circuit that receives a current supply system power input, wherein said regulator outputs a protected and controlled voltage direct current network circuit power feed via a portion of said second electrical communication, in addition a hot swap circuitry is included in said regulator circuit and said data communication hub to facilitate replacing, adding, or subtracting said radio transceivers to and from said second electrical communication from said central power supply and data communication hub without shutting down said modular meshed radio nodes networking topology for kinematic objects.

15. A modular meshed radio nodes networking topology for kinematic objects according to claim 14 wherein said direct current or alternating current to direct current converter regulator circuit and said data communication hub further comprises circuitry to utilize either four wire or eight wire network cable systems for said second electrical communication.

16. A modular meshed radio nodes networking topology for kinematic objects according to claim 10 wherein said antenna array assembly further comprises beam forming circuitry to operationally create an adaptive array smart antenna array to direct radio frequency energy to where it is needed to establish said wireless primary wireless data transmission.

17. A modular meshed radio nodes networking topology for kinematic objects according to claim 12 wherein each said radio transceiver further comprises circuitry for cryptography and key distribution for node to node and access control for the mesh nodes, wherein public and private keys can be generated from each node in said mesh network or alternatively be generated from a server and propagated to each node.

18. A modular meshed radio nodes networking topology for kinematic objects according to claim 12 wherein each said radio transceiver further comprises deep machine learning algorithms for network routing to determine a network routing a shortest reliable path, determine channel assignment to minimize interference level and data rate adaption based on the operating wireless environment.

19. A modular meshed radio nodes networking topology for kinematic objects utilizing a cellular or satellite backhaul or bearers communication connection component utilizing a secondary wireless data transmission, a plurality of spatially selected locations within a cargo area, and an article of cargo, said modular meshed radio nodes networking topology for kinematic objects comprising:
(a) a central protected and conditioned power supply and data communication hub that is in a first electrical communication with the backhaul connection component;
(b) a plurality of independent radio transceivers each with an integral antenna array forming an access point, wherein each said radio transceiver has structure to be removably engagable to a selected location within the cargo area, wherein each radio transceiver is in a second electrical communication with said central power and data hub;
(c) a self contained sensor including structure to be removably engaged to the article of cargo, wherein said modular meshed radio nodes networking topology for kinematic objects is to operationally facilitate a primary wireless data transmission to or from said sensor to at least one of said radio transceivers that in turn send or receive data via said second electrical communication to said central power and data hub for ultimate data communication via said first electrical communication to or from the cellular or satellite backhaul or bearers connection component utilizing the secondary wireless data transmission; and
(d) a perceptible component that is in a third electrical communication with said central power and data hub.

20. A modular meshed radio nodes networking topology for kinematic objects according to claim 19 wherein at least one of said plurality of independent radio transceivers further comprise circuitry for a multiple in multiple out (MIMO) operation including the capability for leverage of the multipath and/or delayed signal from the same source of said primary wireless data transmission signals.

21. A modular meshed radio nodes networking topology for kinematic objects according to claim 19 wherein said plurality of independent radio transceivers each further comprise circuitry for a mesh network operation, wherein said mesh network circuitry is selected from the group consisting of a local network configuration or a backhaul (cloud) configuration.

22. A modular meshed radio nodes networking topology for kinematic objects according to claim 19 wherein said central protected and conditioned power supply and said data hub includes an Ethernet switch or router.

23. A modular meshed radio nodes networking topology for kinematic objects according to claim 19 wherein said central protected and conditioned power supply and data communication hub is constructed of a direct current or alternating current to direct current converter regulator circuit that receives a current supply system power input, wherein said regulator outputs a protected and controlled voltage direct current network circuit power feed via a portion of said second electrical communication, in addition a hot swap circuitry is included in said regulator circuit and said data communication hub to facilitate replacing, adding, or subtracting said radio transceivers to and from said second electrical communication from said central power supply and data communication hub without shutting down said modular meshed radio nodes networking topology for kinematic objects.

24. A modular meshed radio nodes networking topology for kinematic objects according to claim 23 wherein said direct current or alternating current to direct current converter regulator circuit and said data communication hub further comprises circuitry to utilize either four wire to eight wire for said second electrical communication.

25. A modular meshed radio nodes networking topology for kinematic objects according to claim 19 wherein said radio transceivers further comprise circuitry that is either Wi Fi or Ultra Wide Band.

26. A modular meshed radio nodes networking topology for kinematic objects according to claim 19 wherein said sensor further comprises circuitry selected from the group consisting of a position detector, a temperature detector, a pressure detector, a light detector, an acceleration detector, or a unique sensor identification identifier.

27. A modular meshed radio nodes networking topology for kinematic objects according to claim 19 wherein said antenna array assembly further comprises beam forming circuitry to operationally create an adaptive array smart antenna array to direct radio frequency energy to where it is needed to establish said wireless primary wireless data transmission.

28. A modular meshed radio nodes networking topology for kinematic objects according to claim 21 wherein each said radio transceiver further comprises circuitry for cryptography and key distribution for node to node and access control for the mesh nodes, wherein public and private keys can be generated from each node in said mesh network or alternatively be generated from a server and propagated to each node.

29. A modular meshed radio nodes networking topology for kinematic objects according to claim 21 wherein each said radio transceiver further comprises deep machine learning algorithms for network routing to determine a network routing a shortest reliable path, determine channel assignment to minimize interference level and data rate adaption based on the operating wireless environment.
